(19) United States
(12) Patent Application Publication
(10) Pub. No.: US 2025/0089132 A1
(43) Pub. Date: Mar. 13, 2025

(54) ELECTRIC HEATING FILM

(71) Applicants: Chih-Chiang Pai, Taoyuan (TW); Meng-Kuei Lin, Taoyuan (TW); Chin-An Tsai, Taoyuan (TW); Chih-Jung Tsui, Taoyuan (TW)

(72) Inventors: Chih-Chiang Pai, Taoyuan (TW); Meng-Kuei Lin, Taoyuan (TW); Chin-An Tsai, Taoyuan (TW); Chih-Jung Tsui, Taoyuan (TW)

(73) Assignee: Young Fast Optoelectronics Co., Ltd., Taoyuan (TW)

(21) Appl. No.: 18/244,928

(22) Filed: Sep. 12, 2023

(51) Int. Cl. H05B 3/46; H05B 3/14

(52) U.S. Cl. CPC H05B 3/46; H05B 3/141; H05B 3/146; H05B 3/84; H05B 2203/003; H05B 2203/013

(57) ABSTRACT

A heating film includes a base layer and a heating layer. The heating layer is disposed on a surface of the base layer and is defined with multiple equivalent heating zones. Each equivalent heating zone is disposed with a heating wire. The outside of the equivalent heating zones is disposed with an input conductive wire and an output conductive wire. The input conductive wire and the output conductive wire are connected to each heating wire in parallel. Each of the equivalent heating zones has substantially the same area. The heating wire in each equivalent heating zone has substantially the same path width and total path length.

### BACKGROUND

### Technical Field

The invention relates to electric heating defogging, particularly to an electric heating film.

### Related Art

The temperature difference makes moisture condense on a surface of an object. For 3C electrical products, condensed moisture will damage electronic components and circuits, especially the condensation of moisture in front of the display of an electrical product will cause fogging. This will seriously detract from the visibility of the display. Therefore, installing an electric heater sheet in an electric product can evaporate condensed moisture and eliminate fog that stays on the display. The structure of a traditional electric heater sheet is disposed with multiple electric heating wires which are parallel arranged on an insulative substrate. The heating wires are kept at a certain distance from each other to be arranged at intervals. The heater sheet is attached to an electronic circuit or a display. When being energized, the electric heating conversion effect is generated by the resistance of the heating wires to heat the electronic circuit or the display to eliminate condensed moisture or fog. However, when the traditional electric heater sheet is working, the heat generated is concentrated on the electric heating wires, and the nearby area between the two electric heating wires must be heated slowly through heat conduction. As a result, in addition to prolonging the time required for defogging, the uneven heat distribution may also adversely affect the operation of some electronic components that are not resistant to high temperatures, especially the internal stress of the glass of the display. After long-term repeated operation, the display will fail. Therefore, how to accelerate the heating speed of an electric heater sheet and improve the uniform distribution of heat is an unresolved problem currently.

### SUMMARY

The invention provides an electric heating film, which has fast heating speed and uniform distribution of heat in the heating action zone to avoid the concentration of thermal stress to cause damage of electric components.

To accomplish the above object, the invention provides an electric heating film, which includes a base layer and at least one heating layer. The base layer is a dielectric layer. The at least one heating layer is disposed on a surface of the base layer and is defined with multiple equivalent heating zones. Each equivalent heating zone is disposed with a heating wire. The outside of the equivalent heating zones is disposed with an input conductive wire and an output conductive wire. The input conductive wire and the output conductive wire are connected to each heating wire in parallel. Each of the equivalent heating zones has substantially the same area. The heating wire in each equivalent heating zone has substantially the same path width and total path length.

In an embodiment of the invention, a path width of each of the input conductive wire and the output conductive wire is greater than a path width of the heating wire.

In an embodiment of the invention, the base layer is made of glass, polyethylene terephthalate (PET), polycarbonate (PC), polymethyl methacrylate (PMMA), polyethylene (PE), polystyrene (PS), polypropylene (PP), polyvinyl chloride (PVC), polyimide (PI) or polyurethane (PU), but not limited to these, any other soft, hard or flexible transparent substrates are available.

In an embodiment of the invention, the heating layer is a heating film, and the heating film has a thickness below 10 μm and a surface resistance above 0.15 Ω/sq.

In an embodiment of the invention, the heating layer includes at least one auxiliary conductive film, the auxiliary conductive film and the heating film are superposed together with electric connection, and the auxiliary conductive film is greater than or equal to the heating film in surface resistance.

In an embodiment of the invention, each of the auxiliary conductive film and the heating film is made of metal film, metal oxide film or carbon nano tube film. The metal oxide film is made of indium tin oxide (ITO), indium zinc oxide (IZO), zinc aluminum oxide (AZO), tin antimony oxide (ATO) or polyethylenedioxythiophene (PEDOT).

In an embodiment of the invention, as a transparent heating film, the metal film is a metal mesh film with a transmittance above 90%.

In an embodiment of the invention, an upper surface and a lower surface of the base layer are separately disposed with the heating layer.

In view of this, the inventors have devoted themselves to the above-mentioned prior art, researched intensively and cooperated with the application of science to try to solve the above-mentioned problems. Finally, the invention which is reasonable and effective to overcome the above drawbacks is provided.

### BRIEF DESCRIPTION OF THE DRAWINGS

FIG. 1 is a plan view of the heating layer of the first embodiment of the invention;

FIG. 2 is a cross-sectional view along line II-II in FIG. 1;

FIG. 3 is a cross-sectional view of the second embodiment of the invention; and

FIG. 4 is a cross-sectional view of the third embodiment of the invention.

### DETAILED DESCRIPTION

The appended drawings depict preferred embodiments of the invention. To depict the technical features of the invention more clearly and to make them understood more easily, parts in the drawings are not drawn according to their corresponding sizes. Some sizes and other relative scales have been enlarged. Irrelative details are not completely depicted for simplification.

The electric heating film of the invention includes a base layer 1 and at least one heating layer 2. The at least one heating layer 2 is disposed on a surface of the base layer 1. The heating layer 2 is defined with multiple equivalent heating zones A1, A2, A3. Each equivalent heating zone A1, A2, A3 is disposed with a heating wire 21, 22, 23. The pattern of each heating wire 21, 22, 23 may fill the equivalent heating zone A1, A2, A3 on which it is located to make the equivalent heating zones A1, A2, A3 uniformly and instantly heated for dehumidifying. The outside of the equivalent heating zones is disposed with an input conductive wire 24 and an output conductive wire 25. The input conductive wire 24 and the output conductive wire 25 are connected to each heating wire 21, 22, 23 in parallel. The parallel connection is used to lower the load impedance to increase the current passing through the load area under the fixed voltage. In particular, each of the equivalent heating zones A1-A3 has substantially the same area. The heating wire 21-23 in each equivalent heating zone has substantially the same path width W1 and total path length. Therefore, each heating wire 21-23 has substantially the same path impedance to make each equivalent heating zone A1-A3 have substantially the same heating efficiency to accomplish the object of evenly heating when electric heating is working. Each of the path width W2 of the input conductive wire 24 and the path width W3 of the output conductive wire 25 is greater than the path width W1 of the heating wire 21-23. The enlarged path width can lower path impedance to reduce heating of the input conductive wire 24 and the output conductive wire 25.

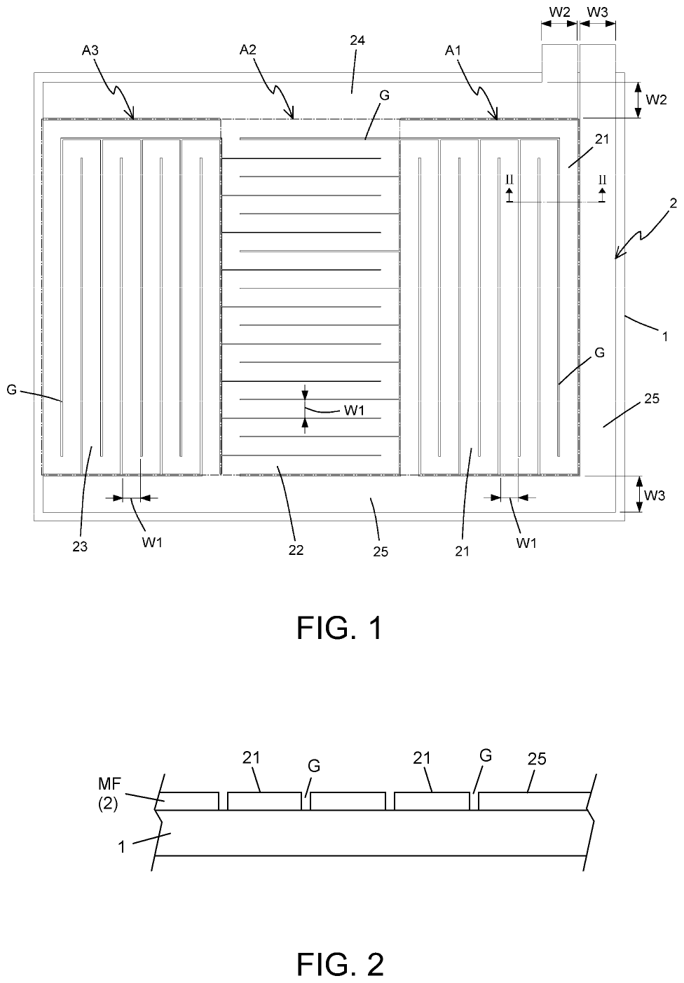

FIGS. 1 and 2 depict a preferred embodiment of the invention. In the embodiment, the base layer 1 is made of dielectric material such as polyethylene terephthalate (PET). The heating layer 2 is a heating film MF disposed on the base layer 1, such as a conductive film containing copper. The heating film MF has a thickness below 10 μm and a surface resistance about 0.25 Ω/sq. The heating layer 2 is formed with multiple insulative gaps G by chemical etching or laser grooving. Preferably, a width of the insulative gap G is greater than 0.05 mm to guarantee insulation. The insulative gap G defines the input conductive wire 24, the output conductive wire 25 and each heating wire 21-23 on the heating layer 2. The invention can directly produce all the required paths on the same conductive film at one time to effectively simplify the manufacturing process of the heating sheet and eliminate the process of the electric connections of I/O conductive wires and heating wires in the traditional heating sheet. In an embodiment applied to a heating film with a size of 202.8 mm×270.4 mm, the path impedance of each heating wire 21-23 in each equivalent heating zone A1-A3 is about between 44.2Ω and 44.5Ω, the path impedance of the input conductive wire 24 is about between 1.7Ω and 2.5Ω and the path impedance of the output conductive wire 25 is about between 5.3Ω and 6Ω. Accordingly, when electric heating is working, the three equivalent heating zones A1-A3 have substantially the same heating efficiency to make the temperature evenly distributed in the heated areas to avoid concentration of thermal stress to damage the structure.

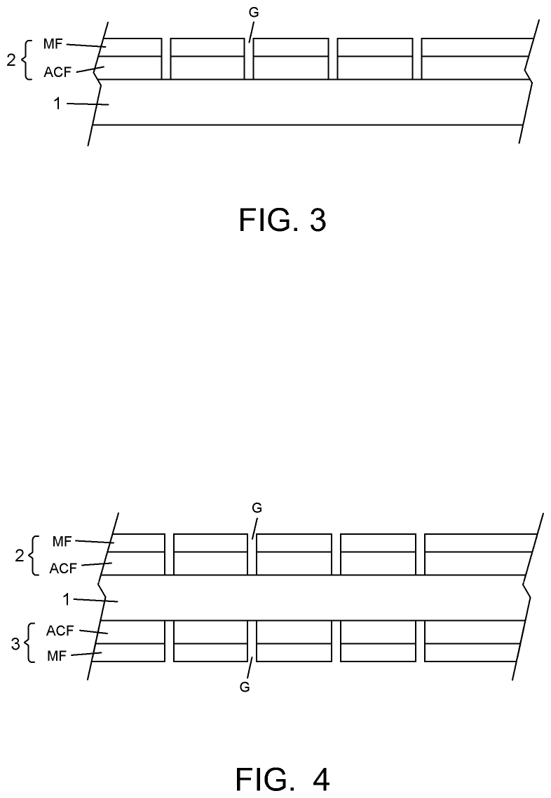

FIG. 3 shows a cross-sectional view of another preferred embodiment, which has a similar structure to the above embodiment. The primary difference therebetween is the composition of the heating layer 2. In the embodiment, the heating layer 2 further includes an auxiliary conductive film ACF in addition to the heating film MF. The auxiliary conductive film ACF and the heating film MF are superposed together with electric connection. They both may adopt conductive films made of identical or different materials, for example, the auxiliary conductive film ACF is an indium tin oxide (ITO) conductive film and the heating film MF is a conductive film containing copper. More preferably, the auxiliary conductive film ACF is greater than or equal to the heating film MF in surface resistance, for example, the surface resistance of the auxiliary conductive film ACF is 0.25-0.3 Ω/sq when the surface resistance of the heating film MF is 0.25 Ω/sq. The auxiliary conductive film ACF and the heating film MF on the heating layer 2 share the input conductive wire 24, the output conductive wire 25 and the heating wires 21-23 (as shown in FIG. 1). By the auxiliary conductive film ACF and the heating film MF, which are electrically connected, the durability of the heating layer 2 can be improved and the heating layer 2 can still works by connection of the auxiliary conductive film ACF even if the paths of the heating film MF are broken. In addition, such a heating layer 2 with a lamination of multiple conductive films has a great anti-bending effect, so it has potential ability of being attached on a curve.

FIG. 4 shows a cross-sectional view of a still another preferred embodiment of the invention, which is a varied structure of the above embodiment. In the embodiment, an upper surface and a lower surface of the base layer 1 are separately disposed with a heating layer 2, 3. The circuit patterns of the heating layers 2, 3 may be entirely identical, partially identical or entirely different. For example, when entirely identical, the equivalent heating zones A1-A3 on the two heating layers 2, 3 are arranged correspondingly in position, so the superposed equivalent heating zones A1-A3 can raise the temperature of that position.

The electric heating film of the invention may be attached on a surface of an element to be heated to eliminate condensed moisture or fog by heating the element. In addition to a single film attached on a surface of an element to be heated, it is also available that multiple films are laminated or arranged in a matrix on a surface of an element to be heated. In addition, when the electric heating film is disposed on a display or a transparent window (such as a vehicle window), the electric heating film is transparent. As a transparent heating film, its base layer and the heating layer are made of transparent material. The base layer 1 may adopt a film of transparent glass or a transparent PET film and the heating film MF and the auxiliary conductive film ACF, which form the heating layer 2, may adopt a metal mesh film or an ITO conductive film with a transmittance above 90%.

While this disclosure has been described by means of specific embodiments, numerous modifications and variations could be made thereto by those skilled in the art without departing from the scope and spirit of this disclosure set forth in the claims.

What is claimed is:

1. An electric heating film comprising:
a base layer, being a dielectric layer; and
at least one heating layer, the at least one heating layer is disposed on a surface of the base layer, defined with multiple equivalent heating zones, each equivalent heating zone being disposed with a heating wire, an outside of the equivalent heating zones being disposed with an input conductive wire and an output conductive wire, and the input conductive wire and the output conductive wire being connected to each heating wire in parallel;
wherein each of the equivalent heating zones has substantially the same area, and the heating wire in each equivalent heating zone has substantially the same path width and total path length.

2. The electric heating film of claim 1, wherein a path width of each of the input conductive wire and the output conductive wire is greater than a path width of the heating wire.

3. The electric heating film of claim 1, wherein the base layer is made of glass, polyethylene terephthalate, polycarbonate, polymethyl methacrylate, polyethylene, polystyrene, polypropylene, polyvinyl chloride, polyimide or polyurethane.

4. The electric heating film of claim 1, wherein the heating layer is a heating film, and the heating film has a thickness below 10 μm and a surface resistance above 0.15 Ω/sq.

5. The electric heating film of claim 4, wherein the heating layer further comprises at least one auxiliary conductive film, the at least one auxiliary conductive film and the heating film are superposed together with electric connection, and the auxiliary conductive film is greater than or equal to the heating film in surface resistance.

6. The electric heating film of claim 5, wherein each of the auxiliary conductive film and the heating film is made of metal film, metal oxide film or carbon nano tube film.

7. The electric heating film of claim 6, wherein the metal film is a metal mesh film with a transmittance above 90%.

8. The electric heating film of claim 6, wherein the metal oxide film is made of indium tin oxide, indium zinc oxide, zinc aluminum oxide, tin antimony oxide or polyethylenedioxythiophene.

9. The electric heating film of claim 1, wherein an upper surface and a lower surface of the base layer are separately disposed with the heating layer.
